(19) United States
(12) Patent Application Publication
(10) Pub. No.: US 2011/0027166 A1
(43) Pub. Date: Feb. 3, 2011

(54) Chlorate and chlorine dioxide systems adapted for the production of deuterium enriched water

(76) Inventors: Andrew T.B. Stuart, Ravenna (CA); Alistair I. Miller, Deep River (CA); Graeme Norval, Oakville (CA)

Correspondence Address: DOWELL & DOWELL P.C., 103 Oronoco St., Suite 220, Alexandria, VA, 22314, US

(21) Appl. No.: 12/461,028

(22) Filed: Jul. 29, 2009

(51) Int. Cl. C01B 5/02; C25B 1/00; C25B 9/00; B01J 8/00

(52) U.S. Cl. 423/580.2; 205/464; 204/275.1; 422/187

(57) ABSTRACT

The present invention provides a process whereby pre-enrichment of water streams using a hydrogen source and a catalytic isotope exchange method at one or more remote sites to supply water with augmented deuterium concentration to a central heavy water. This central heavy water plant could be a Combined Electrolysis and Catalytic Exchange (“CECE”) heavy water production plant or a Girdler Sulfide heavy water plant. The deuterium content of water at the remote sites is increased and provides water stream(s) with augmented deuterium concentration to feed to the central heavy water production plant. This could be a first stage of the central CECE deuterium enrichment plant, increasing its capacity for heavy water production approximately in the ratio of its enrichment above natural deuterium concentrations. By relatively simple utilization of available deuterium enrichment capacity at the remote sites, advantages are achieved from a larger scale of heavy water production at the central production plant. The invention further provides systems and methods for adapting chlorate and chlorine dioxide systems which produce hydrogen to additionally produce deuterium-enriched water.

### FIELD OF THE INVENTION

This invention relates to technologies for the efficient production of heavy water. More particularly, the present invention relates to the utilization of geographically distributed hydrogen-producing plants for the production of pre-enrichment feed water for a centralized heavy water production process. The invention further relates to systems and methods for adapting chlorate and chlorine dioxide systems which produce hydrogen to additionally produce deuterium-enriched water

### BACKGROUND OF THE INVENTION

The Combined Electrolysis and Catalytic Exchange (henceforth referred to as CECE) heavy water production process extracts heavy water from normal water by a combination of electrolysis and catalytic exchange between the water feeding electrolytic cells and the hydrogen produced in them. The CECE process has previously been described in U.S. Pat. No. 3,974,048 issued to Atomic Energy of Canada Limited on Aug. 10, 1976.

The primary components of a normal multi-stage CECE process are each stage's hydrogen water catalytic isotope exchange enrichment columns, electrolytic cells and, in the case of water electrolysis cells, hydrogen recombination and vapor scrubber columns in the oxygen-stream. The catalytic exchange columns enrich water flowing down the column by stripping deuterium from the up-flowing hydrogen gas, with conditions always favoring deuterium transfer to the liquid. Electrolytic cells provide a bottom reflux flow by converting the enriched liquid leaving the catalytic exchange column into hydrogen gas. The electrolytic cells in a CECE process not only provide a bottom reflux flow but also enrich the cell liquid inventory. To minimize exchange catalyst volume and deuterium hold-up within the process, enrichment is always carried out in a series of stages whose scale decreases approximately in inverse proportion to the concentration fed from one stage to the next. Such a series is usually described as a cascade.

The unit cost of heavy water produced by the CECE process is heavily dependent on the scale of operation because the deuterium content of natural water is only about one part in six to seven thousand. Hence 1 MW of water electrolysis can produce only about 150 kg per annum of heavy water. Furthermore, the nature of the process causes substantial fixed, overhead costs for inter alia provisions against loss of enriched product, for analysis, control and supervision. Consequently, application of the process to small-scale electrolytic production of hydrogen is not economic. While water electrolysis is rarely produced on scales of more than a few megawatts, the CECE process for heavy water production fed with the deuterium content of natural water only becomes economic when (1) the scale of operation of the water electrolysis reaches about 100 MW and (2) the cost of the electrolysis is largely borne by the sale of hydrogen or other electrolytic product.

The Combined Industrial Reformer and Catalytic Exchange (CIRCE) process is described by Miller in “Heavy Water: A Manufacturers' Guide for the Hydrogen Century”, [Canadian Nuclear Society Bulletin, vol. 22, no. 1, 2001 February]. A conventional steam-methane reformer (SMR) for the production of hydrogen undergoes a variety of modifications to produce a water stream with a deuterium concentration substantially above naturally occurring abundance—subsequently referred to as deuterium-enriched water. This deuterium-enriched water could be further enriched to high purity heavy water in a cascade at the site of the reformer by various methods such'as the CECE process or the bi-thermal hydrogen-water exchange process. However, the required modifications to the SMR are expensive relative to those required for heavy water production by the CECE process and a typical large-scale steam methane reformer at a single site will extract only enough deuterium for 50 to 70 Mg/a of heavy water (100% basis).

For economic reasons, it is advantageous to seek ways to increase the scale of heavy water production by the CECE process. One approach to increasing the scale of production is described in U.S. Pat. No. 5,591,319—Electrolytic pre-enrichment method and apparatus for the Combined Electrolysis and Catalytic Exchange process—issued on Jan. 7, 1997 to Atomic Energy of Canada Limited. However, this process requires a large portion of physically adjacent integrated water electrolysis cells to produce a very slightly deuterium augmented stream of water without using catalytic isotope exchange enrichment columns. Because the enrichment is small, the scale of the subsequent enrichment step is large.

The total amount of augmented deuterium can also be enhanced by the modified CECE process as taught by LeRoy in U.S. Pat. No. 4,225,402, whereby hydrogen flow rate through a catalytic isotope exchange column is increased though the admixture of a non-electrolytic source of hydrogen. However, LeRoy requires a source of non-electrolytic hydrogen to be in proximity to the catalytic exchange column and the potential for increased production is at most a factor of three.

Another example of the benefits of centralization is contained in U.S. Pat. No. 5,468,462—Geographically Distributed Tritium Extraction Plant and Process for Producing Detritiated Heavy Water using Combined Electrolysis and Catalytic Exchange Processes—issued on Nov. 21, 1995 to Atomic Energy of Canada Limited. In this invention, tritium gas is extracted and pre-concentrated at dispersed sites close to the sources of tritium production, shipped as tritium-enriched deuteride solid, and then further enriched at a centralized plant. However, this process has the specific objective and is limited to production of a highly enriched DT/D₂ gas phase to enable tritium to be absorbed onto a solid metal hydride for safe transportation to a central site, and requires the use of cryogenic distillation to form a tritium gas stream at the central plant. Furthermore, a tritium-lean heavy water stream is returned to the remote site.

Accordingly, there remains a need for a cost-effective and scalable solution for the production of heavy water that utilizes a centralized CECE process.

### SUMMARY OF THE INVENTION

In the present invention, it has been found that geographically dispersed, existing (or newly planned) hydrogen sources such as those from a steam reformer or electrolytic cell capacity can be advantageously adapted to produce a source of pre-enriched feed water for a centralized process where enrichment to heavy water is completed. If the central plant is a CECE plant, the annual production capacity of heavy water production from this single centralized CECE plant increases approximately in the ratio of the deuterium enrichment above natural deuterium concentrations used to feed the said CECE. Other forms of heavy water production plants, such as the Girdler-Sulfide process can similarly benefit from augmented production. Water feed with augmented deuterium concentration would enhance the economics of production and the number of locations where a CECE process can be sited.

Accordingly, the present invention provides a method for the production of heavy water, comprising the steps of:

a) producing pre-enriched water with an augmented concentration of deuterium at one or more geographically remote hydrogen-producing plants wherein said pre-enriched water is obtained at each plant of said one or more remote plants by:

contacting, in an isotope exchange column, feed water with hydrogen gas produced by a hydrogen-producing process within said each plant;

providing water emerging from said isotopic exchange column to said each plant; and extracting pre-enriched water with an augmented deuterium concentration from within said each plant;

b) transporting said pre-enriched water with an augmented concentration of deuterium to a centralized heavy water plant;

c) providing said pre-enriched water as feed water for said central heavy water plant; and

d) producing heavy water in said centralized heavy water plant.

The invention further provides a system for the production of heavy water, comprising:

a) one or more geographically remote hydrogen-producing plants adapted to produce pre-enriched water with an augmented deuterium concentration, wherein each plant of said one or more remote plants comprises an isotope exchange column, and wherein said each plant is adapted to:

contact, in said isotope exchange column, feed water with hydrogen gas produced by a hydrogen-producing process within said each plant;

provide water emerging from said isotopic exchange column to said each plant, and

extract pre-enriched water with an augmented deuterium concentration from within said each plant;

b) a central heavy water plant, wherein said central heavy water plant is configured to receive as feed water said pre-enriched water with an augmented concentration of deuterium; and

c) means to transport said pre-enriched water with an augmented concentration of deuterium to said central heavy water plant.

In a preferred embodiment of the invention, at least one of the remote plants is a chlorate plant that is adapted to produce deuterium-enriched water.

The invention further provides a chlorate plant that is adapted or designed for the additional production of deuterium-enriched water. The chlorate plant is configured to include an isotope exchange column through which feed water to the plant is initially fed, where it contacts, in a counter-current arrangement, hydrogen gas produced in an electrolytic cell within the chlorate plant. The enriched water emerging from the column is then preferably fed to the plant, where it is preferably further enriched by the conversion process in the electrolytic cell.

Accordingly, the invention also provides an apparatus for the production of deuterium-enriched water, comprising:

a) a chlorate production system, said system comprising an electrolytic cell for electrolyzing an aqueous mixture comprising brine and hydrochloric acid, wherein said electrolytic cell produces hydrogen gas;

b) an isotope exchange column, wherein feed water for said chlorate production system is first provided to said isotope exchange column and flows counter-current to said hydrogen gas within said isotope exchange column before entering said chlorate production system;

c) means for the extraction of deuterium-enriched water from said chlorate production system; and

d) means for reducing a loss of deuterium from said chlorate production system.

In another preferred embodiment of the invention, a method is provided for the production of deuterium enriched water with a chlorate plant that further comprises an isotope exchange column, comprising the step of:

a) providing feed water to an isotope exchange column, wherein said feed water contacts and flows counter-current to hydrogen gas within said isotope exchange column;

b) providing water emerging from said isotope exchange column to a chlorate production system, said system comprising an electrolytic cell for electrolyzing an aqueous mixture comprising brine and hydrochloric acid, and wherein said hydrogen gas is produced in said system;

c) extracting deuterium-enriched water from said system; and

d) adapting said system to reduce a loss of deuterium from said system.

In a preferred embodiment of the invention, at least one of the remote plants is an Integrated Process chlorine dioxide production plant that is adapted to produce deuterium enriched water. The invention further provides an Integrated Process chlorine dioxide plant that is adapted or designed for the additional production of deuterium-enriched water. The chlorine dioxide plant is configured to include an isotope exchange column through which feed water to the plant is initially fed, where it contacts, in a counter-current arrangement, hydrogen gas produced in the plant. The enriched water emerging from the column is then preferably fed to the plant, where it is preferably further enriched by the conversion process in the electrolytic cell.

Accordingly, the invention also provides an Integrated Process chlorine dioxide production system adapted for the production of deuterium-enriched water, said system comprising:
a) an isotope exchange column, wherein feed water for said system is first provided to said isotope exchange column, said feed water contacting and flowing counter-current to hydrogen gas within said isotope exchange column before entering said system, wherein said hydrogen gas is produced in said system;
c) means for the extraction of deuterium-enriched water from said system; and
d) means for reducing a loss of deuterium from said system.

In a preferred embodiment, the means for reducing a loss of deuterium from the Integrated Process chlorine dioxide system comprises an isothermal rinse system, wherein said isothermal rinse system comprises an exchange column wherein water vapor in a stream of chlorine dioxide and chlorine gas produced by said system is contacted with liquid water, and wherein said liquid water is enriched with deuterium from said water vapor and wherein deuterium-enriched water emerging from said isothermal rinse system is provided as feed water to said system.

In another preferred embodiment of the invention, a method is provided for the production of deuterium enriched water with Integrated Process chlorine dioxide plant that further comprises an isotope exchange column, comprising the step of:
a) providing feed water to an isotope exchange column, wherein said feed water contacts and flows counter-current to hydrogen gas within said isotope exchange column;
b) providing water emerging from said isotope exchange column to an Integrated Process chlorine dioxide production system, wherein said hydrogen gas is produced in said system;
c) extracting deuterium-enriched water from said system; and
d) adapting said system to reduce a loss of deuterium from said system.

A further understanding of the functional and advantageous aspects of the invention can be realized by reference to the following detailed description and drawings.

### BRIEF DESCRIPTION OF THE DRAWINGS

The embodiments of the present invention are described with reference to the attached figures, wherein:

FIG. 1 is a flow diagram of a three-stage conventional CECE process.

FIG. 2 shows the aggregation of multiple remote sources of pre-enriched water and shipment to a centralized CECE plant.

FIG. 3 is a flow diagram of the first and second stages of a CECE process with a remote electrolytic pre-enrichment stage.

FIG. 4 shows a typical flow diagram of a sodium chlorate production system.

FIG. 5 shows a modified sodium chlorate production system incorporating an isotope exchange column for pre-enrichment of water

FIG. 6 shows a schematic of an Integrated Process system for the production of chlorine dioxide.

FIG. 7 shows a simplified schematic of another Integrated Process system for the production of chlorine dioxide.

FIG. 8 shows a generalized Integrated Process system for the production of chlorine dioxide.

FIG. 9 shows a generalized Integrated Process system for the production of chlorine dioxide that is adapted for the production of deuterium enriched water.

FIG. 10 shows a remote pre-enrichment stage with deuterium extraction further enhanced by addition of recovery of deuterium from a separate, additional hydrogen stream.

FIG. 11 shows a centralized CECE plant fed by a pre-enriched deuterium stream with deuterium extraction further enhanced by addition of recovery of deuterium from a separate, additional hydrogen stream.

### DETAILED DESCRIPTION OF THE INVENTION

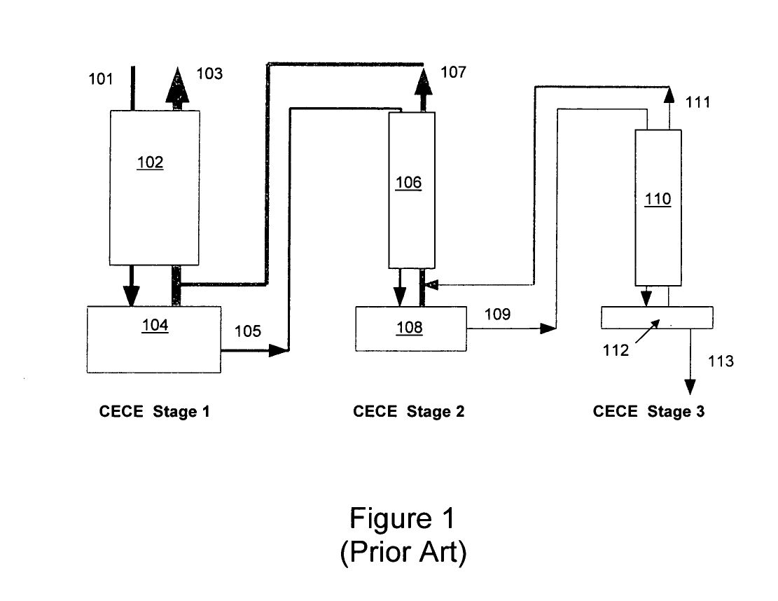

FIG. 1 illustrates a conventional, prior art three-stage CECE (“N-CECE”) process as known in the art. The process is similar to that described in U.S. Pat. No. 3,974,048. In the first stage of the CECE process, input feed liquid water from feed source 101 passes down through a hydrogen gas/liquid water deuterium exchange catalyst column 102 in the course of which the deuterium content of the water is increased, into electrolytic cells 104. Hydrogen gas 103 generated in electrolytic cells 104 flows up through catalyst column 102 in the course of which its deuterium content is reduced. A fraction of the water flow 101 is directed as flow 105 to a Stage 2 in which further enrichment occurs in exchange catalyst column 106 before it is converted into hydrogen stream 107 in electrolytic cells 108. The flows of water and of hydrogen in Stage 2 are approximately related to those in Stage 1 in the inverse ratio of the enrichment of deuterium achieved in Stage 1. In a similar manner, a fraction of the water flow 105 is directed as flow 109 to a Stage 3 in which further enrichment occurs in exchange catalyst column 110 before it is converted into hydrogen stream 111 in electrolytic cells 112. Product of nearly pure heavy water is withdrawn in stream 113 from electrolytic cells 112.

Catalyst columns 102, 106 and 110 contain a packed catalyst bed in which the hydrogen gas and liquid water pass in countercurrent exchange relation. The catalyst is typically wet-proofed, hydrophobic and active in the presence of water. The preferred catalyst material is a group VIII metal having a liquid-water repellant organic polymer or resin coating thereon selected from the group consisting of polyfluorocarbons, hydrophobic hydrocarbon polymers of medium to high molecular weight, and/or silicones, and which is permeable to water vapor and hydrogen gas. These types of catalysts are described in U.S. Pat. Nos. 3,981,976 and 4,126,687. Other catalyst configurations can also be used such as the separated-bed catalyst used, for example, in a heavy-water plant that operated in Trail, B.C., Canada [cite Benedict, M., Pigford, T. H. and Levi, H. W., “Nuclear Chemical Engineering”, McGraw-Hill, 1981].

Electrolytic cells 104, 108 and 112 not only provide a bottom reflux by converting the deuterium-enriched liquid leaving catalyst columns 102, 106 and 110, respectively, into hydrogen gas, but also enrich the electrolytic cells liquid inventories. The electrolytic hydrogen produced in the electrolytic cells is depleted in deuterium relative to the electrolyte by virtue of the kinetic isotope effect inherent in the hydrogen evolution reaction. The electrolytic cell separation factor depends on the condition of the cell's cathode and is typically 5-6.

The preceding description provides is a simplified overview of deuterium enrichment with the CECE process. Other details are described in U.S. Pat. No. 3,974,048. As with all deuterium production processes, the number of stages of progressive enrichment in the overall process can vary from as few as two to as many as five.

The present invention provides an improved method and system for the production of heavy water by producing, in a geographically distributed manner, one or more sources of a pre-enriched water feed stream with an augmented deuterium concentration for use with a centralized CECE plant. Sources of a pre-enriched feed stream are hydrogen-producing plants that incorporate, either by design or by modification, a catalytic exchange column in which the deuterium concentration of a water stream is augmented.

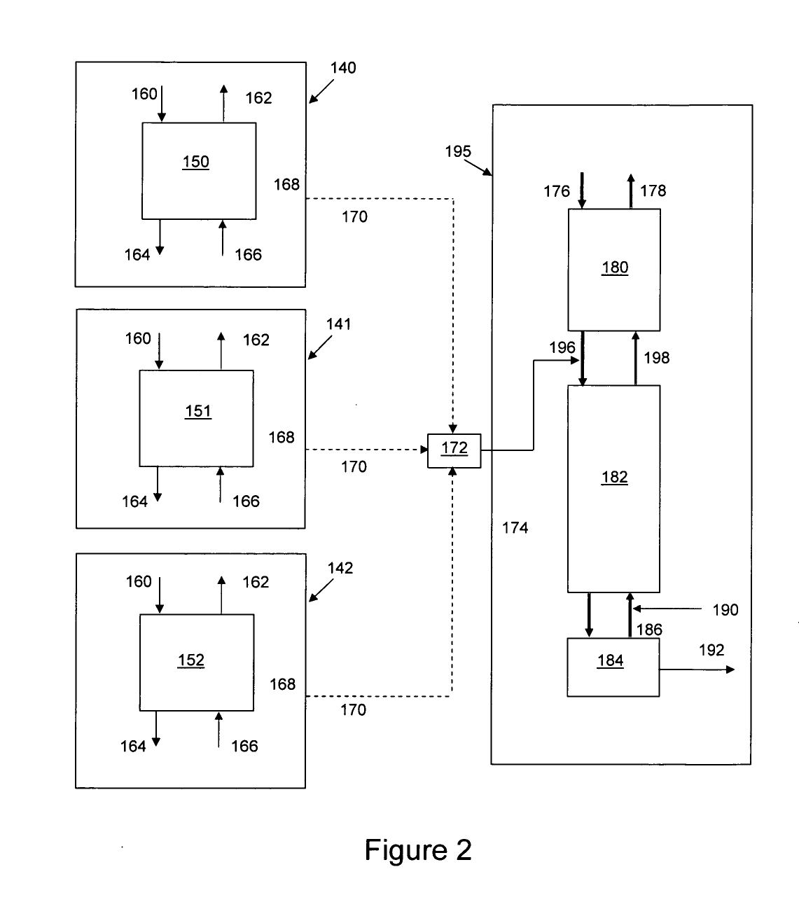

A preferred embodiment of the invention is shown in FIG. 2, which shows a distributed system in which water with an augmented deuterium concentration is produced by one or more geographically distributed plants and transported to a central plant. In this case, a CECE plant is shown. Other heavy water production plants may also be used such as the GS process. Transportation may be achieved by the following non-limiting examples: road vehicles such as large trucks, rail cars, pipelines or ships.

The geographically distributed plants are generally shown at 140, 141 and 142, without illustrating the specific processes by which each plant operates. The plants are adapted to include catalytic exchange columns shown schematically at 150, 151, and 152, which are each fed with hydrogen gas 166 generated within the plants (which exits the columns at 162). Those skilled in the art will recognize that one or more of the hydrogen producing plants may be located geographically near to the central heavy water play (e.g, a central CECE plant), or even on site with the plant.

Feed water, which is preferably natural water 160 or water that has not been previously enriched, flows through catalytic exchange columns 150-152 in a counter-current fashion, where it is enriched by hydrogen gas 166 produced within the plant. The enriched water 164 is then fed to the plants 140-142 and is further enriched by a conversion process involving the production of the hydrogen 166 within the plants (such as an electrolytic cell). Remote plants 140-142 are preferably adapted to prevent or reduce the leakage of water within the plants with an augmented deuterium concentration. Water with an augmented deuterium concentration, shown at 168, is obtained from a selected location with each plant (for example, at a location where the deuterium concentration is maximized, or at a location where the deuterium concentration is high but the concentration of impurities is low, for example, in the water vapor from an electrolytic cell) and is transported 170 to a central CECE plant. Provided the concentrations of deuterium in each stream are similar, (i.e. close to the average of the concentrations), the sources of water with an augmented deuterium concentration are aggregated 172 to provide a water feed 174 with an augmented deuterium concentration to a central CECE plant shown generally at 195. In the case of a single remote location producing water with an augmented deuterium concentration, the aggregation step is skipped.

Those skilled in the art will readily appreciate that an optimal extraction point of the water with an augmented deuterium concentration may be dependent on the nature of the hydrogen-producing process used. Furthermore, those skilled in the art will understand that additional subsystems, such as hydrogen recombiners in the oxygen stream, vapor scrubbers and water-vapor equilibrators (not shown in FIG. 2), may be preferably included in distributed plants.

The CECE plant includes a catalytic exchange column stage 182 for further enrichment of deuterium concentration, an electrolysis cell 184, and preferably includes a further exchange column 180 as a stripping section to reduce the concentration of deuterium in the hydrogen gas stream to close to or below naturally occurring deuterium concentrations 178. The stripping section also provides an intermediate location for the introduction of the feed water with an augmented deuterium concentration that prevents or reduces concentration changes due to mixing by natural water 176 also fed to the system. A separate source of feed water 176 of natural concentration is fed to the upper catalytic exchange column 180 and recovers deuterium from the counter-flowing hydrogen gas stream 178. The aggregated water feed 174 is fed to the catalytic exchange column 182 along with water stream 176 entering catalytic exchange column 180, where it is further enriched by counter flowing hydrogen gas 186 produced by the electrolytic cell 184. The CECE facility is shown as a single stage, but preferably includes multiple stages. In FIG. 2, the enriched water stream 192 is passed to a subsequent stage for further enrichment and hydrogen gas 190 from a subsequent stage is also fed to the column 182.

Those skilled in the art will realize that if one or more of the streams 168 from the geographically distributed plants (140, 141, 142) is produced at a substantially lower or higher deuterium concentration water than the others, then it would be preferable for this water to be injected into columns 180 or 182 at optimal points that minimize the amount of separation work required, i.e. at points that optimize the production of heavy water. Alternatively, one or more additional catalytic exchange columns can be included to provide additional preferred points of insertion of the feed water.

In one embodiment of the invention, the distributed generation involves the use of plants that produce hydrogen either as a product or a byproduct of a process that is not dedicated to the production or enrichment of deuterium in water. Also, as described above, the distributed plants produce hydrogen from a conversion process involving water, whereby the concentration of deuterium in water or another solution or liquor within the plant is further augmented. Accordingly, plants or apparatus for feed water pre-enrichment according to the invention may include electrolysis cells or other processes or apparatus such as steam methane reformers modified according to the CIRCE process.

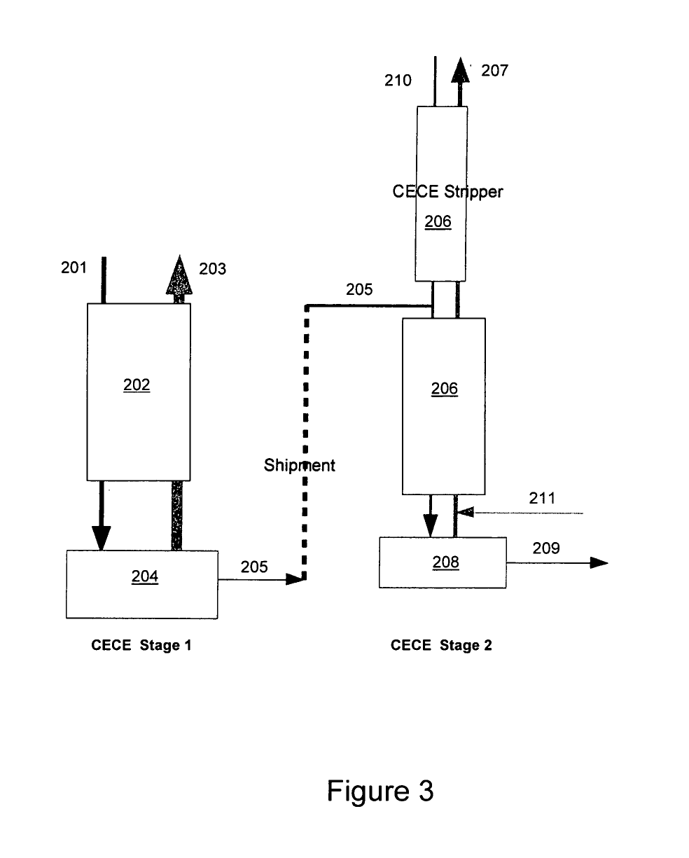

It is useful to note that if such distributed plants were operated primarily to produce heavy water, the cost of electrolysis or other conversion process would likely render heavy water production uneconomic. Such plants are operated for other purposes—e.g. the production of hydrogen gas or sodium chlorate, these water-to-hydrogen converters would not normally be of a scale sufficient to economically justify heavy water production. However, by making comparatively simple modifications to plants operated for purposes other than heavy water production, they can be adapted to produce a side stream of water with sufficiently augmented deuterium concentration that the output of several dispersed plants can be aggregated and fed to the affordable and centralized CECE unit as illustrated in FIG. 3.

As noted above, the geographically distributed (i.e. remote) plants are adapted or modified to include an isotope exchange column that is preferably a catalytic exchange column. Also, in another preferred embodiment of the invention, modifications are made remote plants to limit losses of deuterated substances.

In another embodiment of the invention, at least one remote plant includes two or more stages, each including a hydrogen-producing process, and each stage is configured or adapted to include a catalytic isotope exchange column for the enrichment of water with deuterium in a multi-stage process.

In a preferred embodiment, a remote plant includes two stages, with each stage comprising a hydrogen-producing process. In the first stage, a first catalytic isotope exchange column is included, in which feed water is contacted with and flows counter-current to hydrogen gas produced in the first hydrogen producing process. Water emerging from this column is fed to the first hydrogen-producing process, where it is preferably further enriched in deuterium.

The second stage includes a second catalytic isotope exchange column, in which deuterium-enriched water extracted from a selected location within the first stage (e.g. condensate obtained from a hydrogen-producing electrolytic cell in the first stage) is contacted with and flows counter-current to hydrogen gas produced in the second hydrogen-producing process. Water emerging from the second column is fed to the second hydrogen-producing process, where it is preferably enriched in deuterium. Finally, the pre-enriched water with an augmented concentration of deuterium is obtained from a selected location within the second stage.

In a preferred embodiment, the multi-stage remote plant is a plant configured or adapted to provide a multi-stage Combined Electrolysis and Catalytic Exchange process. However, those skilled in the art will appreciate that the preceding description is not intended to limit this embodiment of the invention to two stages. Furthermore, the stages described above may be multiple stages of a single plant, or may alternatively be nearby but separate hydrogen-producing plants.

Advantageously, the expense associated with close monitoring of deuterium concentrations in the distributed plants 140-142 may be avoided since the deuterium concentration in streams 170 can be allowed to vary. In one embodiment, only an approximate measurement of deuterium concentration in the feed water 168 is provided as an indication of satisfactory catalyst operation.

The invention preferably further includes a scrubbing device for removing traces of deuterium-enriched hydrogen and deuterium-enriched water vapor from co-produced oxygen gas streams by water electrolysis using a portion of the water feed to the process, instrumentation for the measurement and control of deuterium concentrations throughout the process, provision for sufficient leak-tightness as to avoid significant deuterium losses, and other provisions necessary for economic optimization.

In another embodiment of the invention, the centralized heavy water production plant is a Girdler Sulfide plant. The Girdler Sulfide process provides another method for the production of heavy water and is described in Canadian Patent No. 574,293 which is incorporated herein in its entirety by reference.

Briefly, the Girdler Sulfide process is a bi-thermal process in which hydrogen gas is circulated in a closed-loop fashion through a hot exchange column (typically maintained near 130° C.) and a cold exchange column (typically maintained near 30° C.). Feed water is provided to the top of the cold column, where it becomes enriched in deuterium as it extracts deuterium from the hydrogen-sulfide gas. A portion of the enriched water is extracted after passing thought the cold column. The remaining water is fed to the top of the hot column, where its deuterium content is depleted by the counter-flowing hydrogen sulfide gas. Water emerging from the bottom of the hot tower has a deuterium concentration lower than that of the initial feed water. The difference between the equilibrium constants for the exchange of deuterium between liquid water and hydrogen gas effectively provides a source of deuterium-enriched water that is fed to additional Girdler Sulfide plant stages until a sufficiently high deuterium concentration has been achieved.

Accordingly, in a preferred embodiment of the invention, geographically distributed hydrogen-producing plants are adapted or modified to include an isotope exchange column and produce water with an augmented deuterium concentration that is transported to a central Girdler Sulfide heavy water plant.

In a preferred embodiment, pre-enriched water with an augmented deuterium concentration is fed to a Girdler Sulfide plant at an appropriate location where the concentration of deuterium in the plant is close to that of the pre-enriched water. In this manner, the production of the Girdler Sulfide plant may be increased in an amount that depends upon the availability of the pre-enriched water feed—for example, up to around a factor of approximately two to three. The effluent concentration from the Girdler-Sulfide plant will rise as the flow of the pre-enriched water is increased, but the reduction in total heavy water production caused by this will be acceptably small.

Table 1 shows a non-limiting example of the increased production of heavy water that can be realized by providing pre-enriched water with an augmented concentration of deuterium to a Girdler Sulfide plant according to the embodiment disclosed above. The assumed annual flow rate of feed water to the plant is 3.2*10⁶ tonnes and the pre-enriched water was assumed to have a deuterium concentration of 4000 ppm. The example illustrates that a significant increase in production (more than a factor of two) can be obtained by a very small side feed of pre-enriched water.

TABLE 1

| Production Capacity | Impaired Extraction | Pre-Enriched Water |
|---|---|---|
| (tonnes/year) | (tonnes/year) | Required (% of main feed) |
| 100 | 0 | 0 |
| 125 | 3 | 0.2 |
| 151 | 6 | 0.4 |
| 227 | 16 | 1.0 |

As shown in Table 1 above, a Girdler-Sulfide plant with its production augmented to 2.3 times the level without a pre-enriched feed is estimated to forego 7% of total deuterium production. As will be apparent to those skilled in the art, a provision for additional capacity in the final enrichment stage of such a heavy water plant—normally effected with water distillation—may be required to process the additional heavy water production. Thus, for example, an additional water distillation or CECE unit could be added in parallel to the existing final enrichment stage, which usually employs water distillation.

The preferred geographically distributed sources of hydrogen according to the invention are large hydrogen production sources—greater then 5,000 Nm3/h, preferably greater then 50,000 Nm3/h, such as water electrolysis cells, electrolytic cells that produce sodium chlorate, and other processes that produce hydrogen streams along with chemicals that do not contain hydrogen atoms.

Each production source has unique attributes such as hydrogen production rate, water requirements for hydrogen production and water leak tightness of the system. In general, these attributes influence the necessary modifications to the hydrogen generator to integrate an isotope exchange column within the system and the amount of water with significantly augmented deuterium content that can be effectively removed from the system and transported to the centralized CECE plant.

In many cases, the dispersed hydrogen sources used to create the water with augmented deuterium concentration would not be large enough in themselves to justify the additional equipment, labor and supervision necessary to make an economic standalone heavy water production plant producing high purity heavy water. Alternatively, if the incremental equipment necessary to produce the high purity heavy water is a central electrolysis-based CECE plant, such a plant may have enhanced economics at a different site where, for example, the cost of electricity, demand for oxygen or additional demand for hydrogen are more favorable. However, by using one or more of these dispersed supplies of water with augmented deuterium concentration, each dispersed plant can contribute a portion of the feed water to a centralized CECE heavy water production plant optimally located. It is also important to note that the dispersed supplies of water need not have identical deuterium concentrations.

As noted above, those skilled in the art of the CECE process will recognize the need to minimize the uncontrolled leakage of water (or other hydrogen-containing streams) from a geographically remote plant in which the deuterium content is elevated above natural levels. This is particularly important where there is a relatively high molar concentration of deuterium within the water that could potentially leak from the system. The ability to control the hydrogen (protium and deuterium) potential losses will depend upon a number of factors. These include the relative ease and cost with which loss prevention systems can be put in place, the materiality of the loss, and the desired stable concentration of deuterium within the system.

Water entering the CECE columns becomes significantly enriched in deuterium by exchange with hydrogen. Most of the water is converted into hydrogen, also significantly enriched in deuterium. In general, it is preferable to include methods for containing deuterium in water, hydrogen or any other hydrogen-containing chemical formulation within the system.

Two considerations apply: First, every reasonable effort must be made to avoid the escape of water originating in the vicinity of the conversion process (e.g. electrolysis cells) and hydrogen before it has been passed through the catalytic exchange column: quite small losses of either substance significantly reduce a plant's production of deuterium. Second, wherever it can be readily accomplished, water entering the process from beyond the battery limits of the plant should enter through the catalytic exchange column. Water bypassing the exchange column does not directly reduce deuterium production but requires an enlargement of the catalytic exchange column since a smaller water flow tends to impair its capacity for removing deuterium from the hydrogen stream. Preferably, though not essentially, where water is added to the process, it should first be enriched in the column.

In one preferred embodiment, the geographically dispersed sources of water with an augmented deuterium concentration include at least one water electrolysis plant. As discussed above, the normal CECE process is challenged by the dearth of single electrolysis plants in the order of 100 MW or more. However, as the demand for hydrogen grows for energy purposes, including hydrogen produced from renewable energy, it can be expected that the number of water electrolysis plants in the 250 Nm3/h to 6,000 Nm3/hor more will increase. Individually, these will be too small to be economically arranged in a three- or four-stage CECE plant to produce essentially pure heavy water. Furthermore, they might also operate on an intermittent or time of day schedule that would reduce their heavy water recovery. However, water with augmented deuterium concentration, produced with one or more stages of upgrading, may be extracted from such plants and delivered to a centralized CECE plant as enriched feed water with more favorable economics for the production of heavy water.

FIG. 3 shows a specific embodiment of the invention in which electrolytic cells are employed to provide a pre-enriched electrolytic liquid feed (while only one remote plant is shown in this figure, those skilled in the art will readily appreciate that the present invention contemplates a distributed system with one or more of such remote plants). Stage 1 in this embodiment performs the same enrichment function as in the conventional CECE process but is geographically remote from Stage 2. Water with an augmented deuterium concentration, 205, from Stage 1 (preferably obtained water vapor from the electrolytic cell) is transported to a separate Stage 2, which includes a stripping section of exchange catalyst, 206a, such that the deuterium content of hydrogen stream 207 is close to or, preferably, less than the naturally occurring concentration of deuterium. Stage 2 and subsequent enrichment stages are otherwise similar to those of the conventional CECE process using water electrolysis cells.

It is important to note that the present invention provides a significant and inventive improvement over past efforts to improve CECE plants via a pre-enrichment electrolysis step, as in U.S. Pat. No. 5,591,319. As noted above, this prior art method involved the use of geographically local electrolytic cells. More importantly, however, unlike the present invention, the methods disclosed in U.S. Pat. No. 5,591,319 do not include an isotope exchange column in the pre-enrichment stage. The isotope exchange column is clearly seen in FIGS. 2 and 3 of this patent, where the pre-enrichment of U.S. Pat. No. 5,591,319 is achieved by electrolysis alone.

In another embodiment, one or more geographically distributed plants according to the invention is a steam methane reformer integrated with a catalytic exchange column (eg. in FIG. 3, a steam methane reformer integrated with a catalytic exchange column 202, to form the CIRCE process, could also replace the electrolysis cells, 204). In order to achieve world-scale production (200 to 400 Mg/y) and thus low cost production for subsequent upgrading of the water with augmented deuterium, numerous reformers would be required. These would not necessarily be in the same location or close to the optimal location for the centralized CECE plant. In fact, the enrichment in the steam methane reformer has only a secondary effect on how much heavy water could be produced. The main determinant is the hydrogen production rate.

In another preferred embodiment of the invention, the geographically dispersed sources of water with an augmented deuterium concentration include a sodium chlorate plant that is adapted to provide deuterium-enriched water. Sodium chlorate plants employ a process involving the electrolytic conversion of water, with hydrogen gas as a byproduct. Most chlorate plants produce only a small fraction of the total production capacity and none alone can individually support heavy water production by the CECE process. About 1 million tonnes per annum of sodium chlorate is typically produced in North America by this process, consuming approximately 600 MW of power annually. This process could produce up 50 tonnes per year of heavy water according to the present invention.

Sodium chlorate plants are particularly suitable for the enrichment of water with deuterium because, unlike a chlor-alkali plant, only one other product beside hydrogen is produced, and it is a solid containing no hydrogen atoms. This simplifies the confinement and containment of deuterium-enriched hydrogen within the plant.

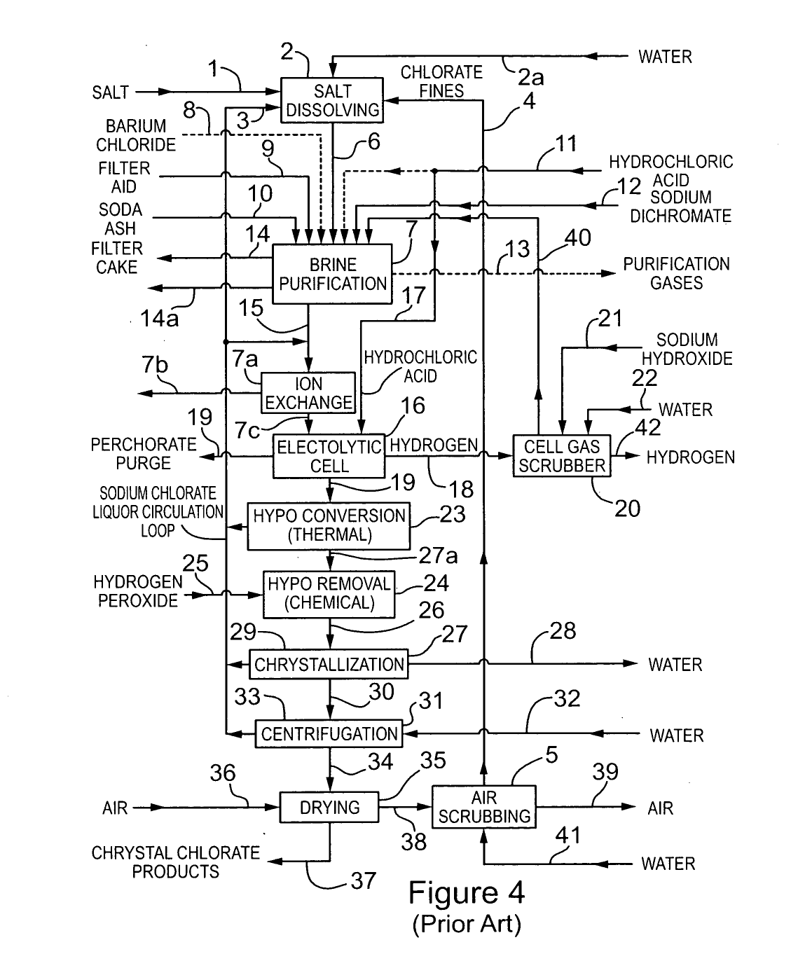

FIG. 4 is a typical flow diagram of a sodium chlorate plant. Salt (typically 98% to 99.5% on a dry basis, with the balance mostly sodium sulfate and generally containing 1% moisture), 1, is fed to salt dissolving tank, 2. Here, water, 2a, re-circulated chlorate depleted liquor, 3, and chlorate fines (in a 20% to 30% aqueous solution), 4, from the air scrubbing system, 5, are also added to the salt dissolving tank.

The resulting brine, 6, is fed to a first stage brine purification system, 7, where various chemicals are added. In older systems, barium chloride, 8, was commonly added to produce barium sulfate that was subsequently precipitated out. In that case hydrochloric acid, 11, is also added to reduce the pH. Other additions include filter aid, 9, soda ash (typically with caustic soda making an alkaline solution so that hydroxides are available for removing magnesium and iron as hydroxides), 10, hydrochloric acid 11, and sodium dichromate, 12. The filter aid and brine purification equipment, 7, removes most of the hardness of certain salt compounds such as calcium carbonate, (departing, as part of an acid back wash, in stream 14a). This reduces the concentration of calcium in the liquor from the order of 100 ppm to 2 ppm. A mixture of purification gases (principally carbon dioxide if the liquor is acidified), 13, as well as a filter cake, 14, are removed from the process. If the liquor is not acidified, the carbon dioxide would leave with the hydrogen at approximately 100 ppm and is washed in the scrubber, 18, with sodium hydroxide (see below).

The partially purified brine, 15, then flows through an ion-exchange unit (typically consisting of two units, one that is under backwash conditions and the other that is in normal operation, 7a, which removes calcium and magnesium to the ppb level. The brine backwash, 7b, from the ion exchange system includes an aqueous purge stream containing small percentage of calcium and magnesium chlorides in an aqueous stream. The flow of calcium carbonate in stream 19 is reduced to the order of ppb. Effluent streams depart from the liquor stream in lines 7b as well as 14a typically to an effluent treatment system (not shown).

The purified brine is then transported to the electrolytic cell system, 16, along with hydrochloric acid, 17. The electrolytic cell system 16, incorporates a circulation system including a level tank where liquor volume can be accumulated or depleted subject to the requirements of operation. Liquor from this tank flows into the bottom of the undivided cells past the electrodes where hydrogen bubbles provide a “gas-lift” effect and pump the chlorate solution into the level tank. The circulation around the electrolysis cells themselves enables an enhanced conversion, via a homogeneous reaction, of the hypochlorite formed at the electrodes to the desired chlorate concentration. The sodium dichromate in solution prevents the reduction of hypochlorite at the cathode. In addition, a modest purge, 19a, of sodium per-chlorate also occurs as this would otherwise build up in the chlorate liquor with an undesirable effect. A hydrogen gas containing stream, 18, and sodium chlorate liquor stream, 19, leave the electrolytic cell system.

The hydrogen gas stream, 18, travels typically through a two-stage cell gas scrubber, 20. The first stage scrubber exposes the hydrogen stream to sodium hydroxide, 21, and secondly, water, 22. The fluids, 40, from the scrubber, 20, return to the brine purification system, 7. The departing hydrogen gas stream, 42, is saturated with water vapor and, on a dry basis, contains approximately 2% oxygen and 3 ppm chlorine.

A portion of the sodium chlorate liquor, now typically 480 g/l of sodium chlorate and 200 g/l salt, 19, overflows the electrolytic cell's brine re-circulation tank, and is fed to a thermal hypo conversion system, 23, where it is heated to 90° C. and an adjusted pH of 6 to achieve the desired conversion of hypochlorite to chlorate. It is then subsequently sent, 23A, to a hypochlorite removal system, 24, where the addition of hydrogen peroxide eliminates the residual hypochlorite.

The partially purified solution, 26, is then fed to crystallization system, 27, it is cooled to 25 C to form crystals. Excess liquor, now depleted in sodium chlorate, is returned, 29, to the liquor circulation loop and eventually to the salt dissolving tank, 2. Water vapor, 28, can be extracted through a chilled vacuum distillation. Such water is normally recycled to the brine dissolving tank, 2.

The sodium chlorate crystal slurry with the mother liquor, 30, and enters a centrifugation system, 31, where water, 32, is used to wash the sodium chloride and sodium dichromate off the crystals. Surplus solution is removed, 33, and returned to the sodium chlorate circulation loop and then to the salt dissolving tank, 2.

The sodium chlorate crystals, 34, enter the dryer, 35, in typically a continuous flow rate at approximately 50 C. They are dried by the addition of air, 36. The air typically enters at low pressure and is heated to increase its drying capacity. The product sodium chlorate crystals are removed, 37, and the wet air stream, 38, passes through a water (added from 41) scrubbing system 5. The scrubbed air, 39, then leaves the system and an aqueous solution of chlorate fines, 4, is returned to the salt dissolving system, 2.

In a preferred embodiment of the invention, a sodium chlorate plant is adapted to provide a simple stand-alone CECE process producing deuterium-enriched water. The quantity of deuterium extracted by the CECE exchange column is only weakly influenced by the enrichment attained in the entire CECE system so the amount of enriched water that is extracted from the modified chlorate plant largely determines the degree of deuterium enrichment. The balance of this water is fed back to the chlorate plant, forming part of its make-up water.

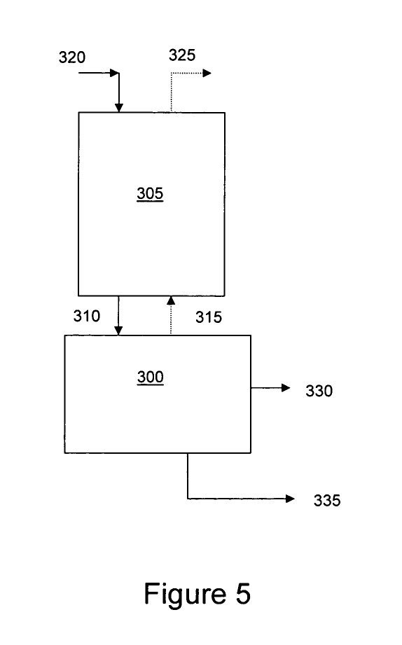

FIG. 5 shows a simplified schematic of a modified sodium chlorate system according to a preferred embodiment of the invention. The chlorate system shown in FIG. 4 is represented generally at 300 in FIG. 5. As one skilled in the art will readily appreciate, the detailed subsystems of FIG. 4 have been omitted in this figure for clarity.

The modifications to the chlorate plant 300 shown in FIG. 5 are henceforth described in relation to the various subsystems shown in FIG. 4. Feed water 320 is fed down a catalytic isotope exchange column 305 in a counter-current arrangement relative to hydrogen gas 315 produced in chlorate system 300 (i.e. the hydrogen stream 42 in FIG. 4). Stream 325 emerges from the catalytic isotope exchange column 305 and has near-natural deuterium content.

Water 310 emerging from the catalytic exchange column 305 is provided to the chlorate system 300. In FIG. 4, the main input water sources for the process enter at 32, 2a and 41. The water balance will depend upon numerous factors including the dryness of the salt, 1, entering the system—especially if this is a brine solution delivered to the plant site. The feed water enriched by the catalytic exchange column 305 may be provided as any or all of these input water sources (i.e. 32, 2a and 41 in FIG. 4). In a preferred embodiment, all water sources pass through the catalytic exchange column 305 before entering the chlorate plant.

Water may be continuously or batch-wise removed from a location within the chlorate plant 300 where it is favorably augmented in deuterium. Locations for this include relatively pure condensate streams that can be created from deuterium-enriched water (either water leaving the bottom of the catalyst column, water extracted from the electrolyte (after purification) and other water streams that leave the battery limits of the plant or could be removed with little or no consequences to the stability of the process.

Preferably, deuterium-enriched water is collected from water that is otherwise evaporated. In a preferred embodiment, the feed water with an augmented deuterium concentration is recovered from condensed vapor originating from the electrolytic cell 16. In another preferred embodiment, deuterium-enriched water is withdrawn from a high purity condensate stream with minimal chlorate liquor-related chemicals in it. Water can also be obtained from the humidity in the hydrogen gas stream obtained after leaving an electrolytic cell 16 and prior to entering the catalytic isotope exchange column. Furthermore, deuterium-enriched water may be extracted from condensate produced from a chlorate crystal drying system 35.

Alternatively, deuterium-enriched water may be extracted from liquid within the cell (but with a low solids content). In this embodiment, the removal of dissolved chemicals is preferably achieved. Deuterium-enriched water may also collected emerging from the bottom of the catalytic exchange column 305. In a further embodiment, water with an augmented deuterium concentration is extracted from the stream feeding water to the electrolysis cell before the addition of sodium chloride.

Those skilled in the art will appreciate that water with an augmented deuterium concentration may be collected from one or more of any of the potential sources described above.

A high level of deuterium in the chlorate system is generally favorable. For example, 4000 ppm is preferred over 2000 ppm, because the incremental work to achieve the additional enrichment is small. The target steady state concentration of deuterium is influenced by an acceptable time to obtain equilibrium (the higher the concentration, the longer time), the volume of catalyst for catalytic isotope exchange enhancement selected (the greater the volume, the higher the cost as well as the higher the impact on process conditions such as pressure drop) and the ability to capture other losses of deuterium from the system (the higher the concentration, the larger the losses of deuterium).

Those skilled in the art of the CECE process will recognize the need to minimize the uncontrolled leakage of water from a sodium chlorate system in which the deuterium content is elevated above natural levels. This is particularly important where there is a relatively high molar concentration of deuterium within the water leaking from the system. Modifications to the sodium chlorate system may be required to minimize these losses. For example, loss of 0.1% of the feed-water to the process at 2000 ppm deuterium would reduce heavy water output by about 2%. Because the concentration of deuterium in hydrogen is much lower than that in equilibrium with water, proportionate losses of hydrogen would be smaller but must still be minimized as hydrogen has a greater propensity for leakage than water.

Potential leak sources where elevated concentrations of deuterium could escape the system, and thus reduce the concentration or the rate of production of deuterium or both, are shown as leak water 335 in FIG. 5, and may correspond to any of the following hydrogen-containing fluids exiting the system shown in FIG. 4:

Water vapor in stream 42

Hydrogen itself in stream 42

Water that may have vaporized in stream 28

Any moisture contained in the purification gases 13

Moisture in the air scrubber system 39

Any residual moisture in the crystal chlorate products 37

Moisture in the filter cake 14

Any other fluids flowing from the brine purification step 14a

The filter-backwash removed from the ion-exchange process 7b

The perchlorate purge stream 19a

The ability to control and reduce the hydrogen (protium and deuterium) losses will depend upon a number of factors. These include the relative ease and cost that loss prevention systems can be put in place, the materiality of the loss, and the desired stable concentration of deuterium within the system.

Water entering the catalytic exchange column becomes significantly enriched in deuterium by exchange with hydrogen. Most of the water is converted into hydrogen, also significantly enriched in deuterium. In general, the following methods would be considered for containing deuterium in water, hydrogen or any other intermediate chemical formulation within the system.

Two considerations apply. First, every reasonable effort must be made to avoid the escape of water originating in the vicinity of the electrolysis cells and of hydrogen before it has been passed through the catalytic exchange column: quite small losses of either substance significantly reduce a plant's production of deuterium.

Second, wherever it can be readily accomplished, water entering the process from beyond the battery limits of the plant should enter through the catalytic exchange column. Water bypassing the exchange column does not directly reduce deuterium production but requires an enlargement of the catalytic exchange column since a smaller water flow tends to impair its capacity for removing deuterium from the hydrogen stream. Therefore, preferably, though not essentially, where water is added to the process, it should first be enriched in the catalytic exchange column. Thus water with augmented deuterium concentration would enter various process operations such as stream 32, 41, 2a, and 22. Also, this water would be selected for use for any dilution requirements of the various chemical additives to the system including 8, 9, 10, 11, 12, and 25 (i.e. barium chloride, filter aid, hydrochloric acid, sodium dichromate, sodium hydroxide, soda ash, and hydrogen peroxide). Furthermore, salt required in the chlorate production process may be dissolved in water that is sourced leaving the bottom of the isotope exchange column. The water from the bottom of the isotope exchange column may also be used in cells, the gas scrubber and centrifugation equipment.

Chlorate plants have well defined solid effluent streams leaving the plant. The filter cake, which typically contains approximately 35% water, is an effluent that could have a significant impact on deuterium losses. Excess liquid from the cake could be recovered and returned to the primary brine purification system to the maximum extent possible. Residual water within the filter cake could be removed through heating, for example, in a drum rolling dryer.

Chlorate plants also have well defined water vapor streams departing the plant. These are generally of lower pressure and pass through pipes in the order of 3″ to 20″ in diameter subject to normal chemical engineering principles. Passing these streams through a water-water vapor equilibration column would reduce the losses of deuterium from the system. The resulting deuterium enriched water leaving such a column would be fed back into the system at a location approximate to its size and deuterium concentration: larger streams may advantageously be returned to an intermediate point in the catalytic exchange column; smaller streams may most conveniently be returned to the chlorate liquor. The resulting deuterium depleted streams include 13, 28, 39, and 42 in FIG. 4.

To further reduce deuterium losses from the plant, air entering the chlorate crystal drying stage should itself be as dry as possible. In a preferred embodiment, air leaving the dryer 35 should pass through a water vapor scrubber and/or a condenser with the resulting liquid water returned to the process.

Alternatively, in the case of the chlorate drying 35 and air scrubbing system, an air re-circulation system may advantageously be deployed whereby the exhaust air 39 is captured in its entirety and re-circulated to the air intake. In general, without re-circulation, some 20% of the process water requirements could be lost through the air dryer. Although the deuterium could be effectively conserved using a water-water vapor equilibration system, condensing water vapor and then and re-circulating the dryer air has the advantage of reducing water loss in the order of 20% of the water requirements for the system. This reduction in absolute water requirements benefits the chlorate production system as well as the recovery of augmented deuterated water streams.

The liquid effluent departing from the ion exchange system 7b, 14a, and the sodium perchlorate purge 19a could have partial recovery of deuterium ions. For example, dilute streams such as those from the ion-exchange backwash 7b that contain high levels of moisture, could be re-circulated to the primary brine purification tank 7 where subsequent reduction of the recycled calcium, magnesium and sulfate salts could be removed during brine purification (precipitation, flocculation, skimming and filtration). Where appropriate, water may be recovered through evaporation either by vacuum distillation or heating.

Those skilled in the art of electrochemical production of chlorates, including sodium chlorate, will understand that such plants are designed to minimize leaks of liquid and gases from the electrolyte, piping and other areas, but no particular effort is extended for organizing the piping in a manner that would conserve deuterium within the electrolyte working solution. Instead, the degree of leak tightness is primarily based on environmental and economic concerns such as the escape of chromium containing liquids, hydrogen gas or chlorine in various forms.

As can be seen in FIG. 4, in general, the water balance around the plant requires water to be added to replace that used to produce hydrogen as well as losses from crystallization, filter cake discharge, losses of humidity from the drying process or purification gases. In the event that a brine solution is the purchased input for feedstock, then part of the required water would arrive with the brine to the chlorate system. In this case, less water is added to the system elsewhere. In the more common circumstance solid salt is purchased and delivered to the chlorate plant, then additional water is required to be added at site. Addition of at least most of the water at the location of chlorate production is the preferred configuration for production of water with augmented deuterium concentrations as management of the process for conservation of deuterium will be facilitated.

In addition to the aforementioned chlorate plant modifications, deuterium enrichment may be further improved by purchasing chemicals that may be consumed in the process, such as barium chloride, filter aid, soda ash, hydrogen peroxide, hydrochloric acid, sodium dichromate and sodium hydroxide, in higher concentrations with minimal amounts of normal water already present (preferably after factoring in cost considerations). Preferably, all dilution is carried out at plant site with water that has passed down through the catalyst exchange column.

In another preferred embodiment, water 28 leaving the crystallization system is re-used in the process, and preferably this condensate is used for brine dissolution as described above.

In yet another embodiment of the modified chlorate plant, surplus pre-enriched water, i.e. water in excess of the required or desired quantity of deuterium-enriched water from the system, can be returned to the plant. For example, such water may come from a source that may include a cell, gas scrubber, crystallization equipment, filter cake departing a brine purification step, air scrubbing system, the said chlorate crystal drying system, and any combination thereof.

The preceding embodiments provide a modified chlorate plant and methods of modifying a chlorate plant for the production of deuterium-enriched water. In a preferred embodiment, one or more remote plants in a distributed heavy water production system (according to previously disclosed embodiments of the invention) is a chlorate plant modified to produce water with an augmented concentration of deuterium.

In another preferred embodiment of the invention, the geographically dispersed sources of water with an augmented deuterium concentration include a chlorine dioxide plant that is adapted to provide deuterium-enriched water. Modern chlorine dioxide plants employ the Integrated Process for the production of chlorine dioxide, which, like the aforementioned chlorate production process, involves the electrolytic conversion of water, with hydrogen gas as a byproduct.

The Integrated Process for the production of chlorine dioxide is disclosed in U.S. Pat. No. 3,920,801, which is incorporated herein by reference in its entirety.

Although not discussed here in detail, those of skill in the art will be familiar with a wide variety of alternative processes for generating chlorine dioxide, including the R6 process, the Lurgi integrated process and the Chemetics integrated process.

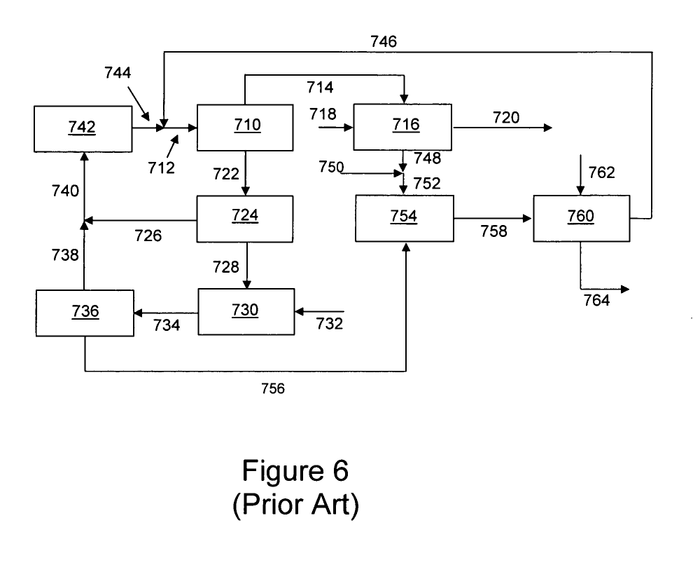

A schematic of an Integrated Process chlorine dioxide system is shown in FIG. 6. While those skilled in the art will recognize that there are several known variants, an Integrated Process plant generally includes three main components: a chlorate electrolysis system, a chlorine dioxide generation system, and a hydrochloric acid synthesis system.

In the embodiment of FIG. 6, the aqueous sodium chloride solution is passed to a chlorate cell 736 wherein part of the sodium chloride is electrolyzed to form sodium chlorate. The resulting aqueous solution of sodium chlorate and sodium chloride may be fed as such to the generator 710, the sodium chloride recycling as a dead load between the generator 710 and the chlorate cell 736. Alternatively, sodium chlorate may be crystallized from the aqueous solution of sodium chlorate and sodium chloride resulting from the chlorate cell 736 with the crystallized sodium chlorate being formed into an aqueous solution for feed to the generator 710, and the sodium chloride being recycled to the chlorate cell 736 for formation of more sodium chlorate.

Sodium dichromate is conventionally used to enhance the efficiency of chlorate production in the chlorate cell 736. Where the sodium chlorate and sodium chloride solution is fed to the generator 710, as in the illustrated embodiment, dissolved sodium dichromate also is fed to the generator. This dichromate feed results in an increase in the concentration of sodium dichromate until the reaction medium is saturated with sodium dichromate, and sodium dichromate crystallizes from the reaction medium along with the sodium chloride. When the precipitated sodium chloride is fed to the chlorate cell, the aqueous solution thereof also will contain the precipitated dichromate. Thus, under steady state conditions in which chlorate cell liquor is fed to the generator and sodium dichromate is used in the chlorate cell, the reaction medium is saturated with respect to sodium dichromate and the sodium dichromate required in the chlorate cell is fed to the chlorate cell with the sodium chloride solution formed from the generator precipitate.

The sodium chlorate solution resulting from the chlorate cell 736 passes by lines 738 and 740 to a reboiler 42 after mixing with the recycle reaction medium in line 726.

The sodium chlorate solution is heated to the required reaction temperature in the reboiler 742 and is discharged therefrom by line 744. The heated sodium chlorate solution in line 44 is mixed with hydrochloric acid fed by line 746 prior to forwarding of the reactants fed by line 712 to the chlorine dioxide generator 710. The recycling dissolved sodium chloride and sodium dichromate, if present, are immediately crystallized from the reaction medium due to the saturated nature of the reaction medium with respect to sodium chloride and sodium dichromate, if used, in the chlorate cell.

Chlorine gas also results from the chlorine dioxide adsorber 716 and is removed therefrom by line 748. A vacuum pump, or other suitable means, may be provided in line 48 to maintain the subatmospheric pressure in the chlorine dioxide generator 710.

The chlorine gas in line 748 may be mixed with additional chlorine gas in line 750, such as from a causticchlorine cell to provide a combined chlorine feed line 752 to a hydrogen chloride reactor 754.

Hydrogen gas formed in the chlorate cell 736 is forwarded by line 56 to the hydrogen chloride reactor 754 wherein part thereof reacts with the chlorine feed in line 752 to form hydrogen chloride in line 758. Alternatively, natural gas may be reacted with the chlorine to form hydrogen chloride.

Hydrogen gas formed in the chlorate cell 736 is forwarded by line 756 to the hydrogen chloride reactor 754 wherein part thereof reacts with the chlorine feed in line 752 to form hydrogen chloride in line 758.

The hydrogen chloride is passed to a hydrogen chloride absorber 760 wherein the hydrogen chloride is adsorbed in water fed by line 762 to form the hydrochloric acid feed line 746. Excess hydrogen is vented by line 764. The embodiment of FIG. 1, therefore, integrates the chlorine dioxide generator with a chlorate cell to provide a system which requires only chlorine, water and energy to provide chlorine dioxide and hydrogen.

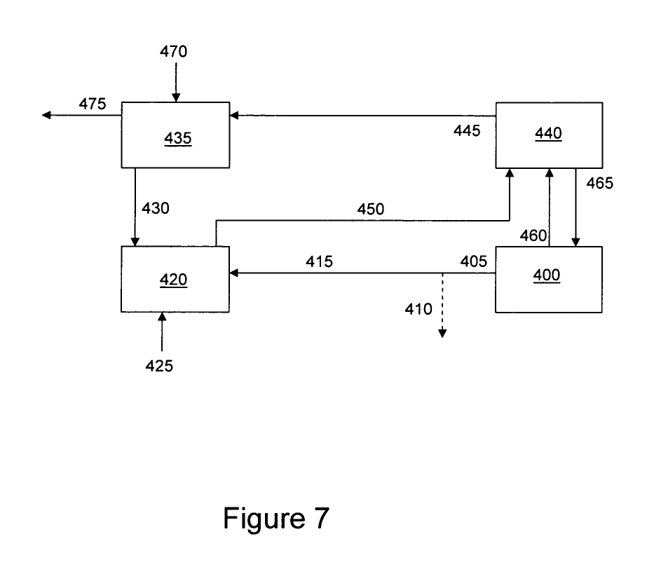

The above process is a variation of the Lurgi process, which is also shown in a simplified schematic in FIG. 7.

The inputs to the Lurgi process include chlorine and water, and the overall reaction takes the form:

Cl₂+4H₂O→2ClO₂+4H₂

As described in connection with FIG. 6, NaClO₃ is produced from water and salt in an electrolytic cell and a chlorate reactor, which are both shown generally a sodium chlorate production system 400 in FIG. 7. The overall chlorate production reaction proceeds according to the formula:

NaCl+3H₂O→NaClO₃+3H₂

with H₂ 405 as a byproduct, a part of which 410 is fed to a HCl synthesis system 420, with the remainder 410 vented or captured as a potential fuel source. NaClO₃ exits the sodium chlorate production system at 460.

The HCl synthesis system 420 produces HCl 450 from hydrogen gas 415, recovered Cl₂ 430 from the ClO₂ separation system 435, and an external feed of Cl₂, and is diluted to an appropriate concentration by input feed water 425. HCl is produced in the system by the reaction:

H₂Cl₂→2HCl

The ClO₂ generator 440 produces ClO₂ and Cl₂ (which exit together at 445) from HCl 450 and NaClO₃ 455, according to the reaction:

2NaClO₃+4HCl→2ClO₂+Cl₂+2NaCl+2H₂O

The product NaCl and unreacted NaClO₃ exit the ClO₂ generator at 465 and is fed to the chlorate production system 400.

As discussed with regard to FIG. 6, the stream 445 exiting the ClO₂ generator contains ClO₂, Cl₂ and moisture. The ClO₂ is absorbed into cold water 470 entering the ClO₂ separation system 435, and exits the system at 475. The separation system further includes a stripper for separating Cl₂430, which is provided to the HCl system 420.

Those skilled in the art will readily appreciate that the simplified system shown in FIG. 7 does not show additional components which may be preferably included, such as a tail gas scrubber system and a chlorine scrubber system for the removal of Cl₂ from the vented H₂ gas. It will also be apparent to those skilled in the art that an Integrated Process plant may be preferentially located nearby to a companion chlor-alkali plant for the production of HCl or Cl₂ as a feedstock to the Integrated Process.

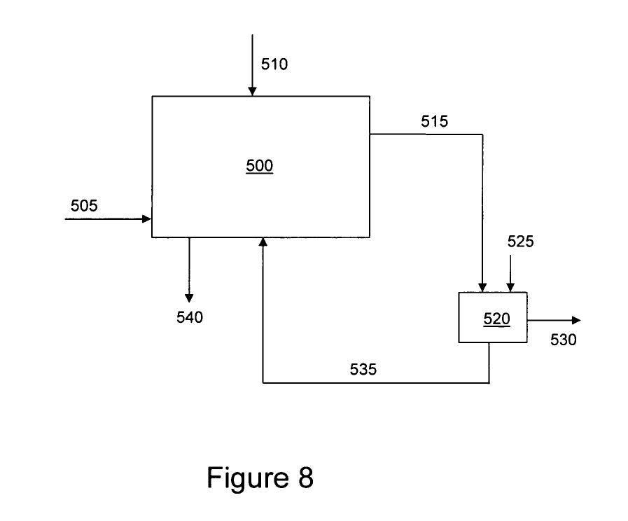

The above examples and descriptions of the Integrated Process for the production of chlorine dioxide illustrate that the Integrated Process can generally be represented according to the schematic shown in FIG. 8. The primary system of the chlorine dioxide system, namely the sodium chlorate production system, HCl synthesis system, and ClO₂ generator generally represented at 500.

Inputs to the system include water 505 and Cl₂ or HCl 510 (depending on the system type). The output from the primary system 505 includes ClO₂ and Cl₂ (with moisture) that are shown at 515. These gases travel to the ClO₂ separation system 520, where ClO₂ is absorbed by cold water 525 and exits the system as product 530. Cl₂ separated in the ClO₂ separation system is returned to the primary system, where it is fed to the HCl synthesis system as described above. H₂ produced within an electrolytic cell in the primary system 500 is shown exiting the system at 540.

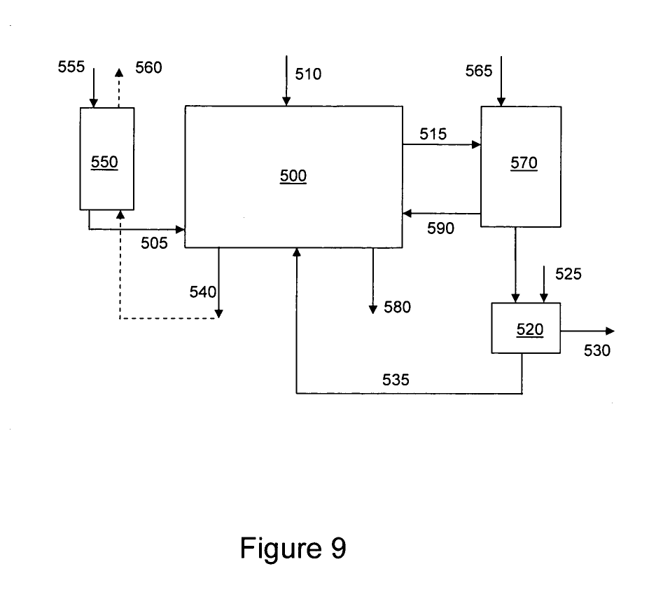

In a preferred embodiment of the invention, an Integrated Process chlorine dioxide system is adapted to produce deuterium-enriched water. As shown in FIG. 9, a general Integrated Process chlorine dioxide plant may be modified to include a catalytic isotope exchange column 550. Water 505 (preferably de-mineralized water) entering the plant is initially fed to the catalytic isotope exchange column 550, where it is contacted with hydrogen gas 540 produced by the primary system in a counter current flow. The water 505 emerging from the column 550 and provided to the primary system 500 is enriched in deuterium due to exchange with the hydrogen gas. The deuterium depleted hydrogen gas 560 emerges from the top of the exchange column.

Since the hydrogen gas is produced by an electrolytic conversion process within the cell involving the conversion of water 505, the aforementioned adaptation of the chlorine-dioxide plant effectively adapts the plant for the enrichment of water with deuterium in a manner similar to that of the CECE process. Enriched water, shown exiting the primary system at 580, may be extracted from a number of possible locations in the plant, which will be readily apparent to those skilled in the art. In a preferred embodiment, deuterium-enriched water is extracted as condensate from vapor in the electrolytic cell within the chlorate production system in 500. Deuterium-enriched water may also be collected from other sources, such from hydrogen gas using a water-vapor scrubber, or from liquid collected (and subsequently purified for the removal of chemical impurities) from an electrolytic cell. Preferably, any surplus deuterium-enriched water that is extracted or collected from the system may be returned to the system.

As noted above with regard to a preceding embodiment of the invention in which a chlorate plant is adapted to provide deuterium-enriched water, the concentration of deuterium in the extracted water 580 depends on the degree to which deuterium is kept within the system.

The main potential source of deuterium leakage from an Integrated Process system is the loss of deuterium in the moisture within the ClO₂ and Cl₂ stream 515. This deuterium leaves the system shown in FIG. 7 within the product stream 530.

In modern Integrated Process plants, the ClO₂ and Cl₂ are obtained in stream 515 by a vacuum process that prevents the partial pressure of ClO₂ from exceeding a threshold beyond which significant decomposition of ClO₂ will occur. This threshold is known in the art to be approximately 8-10 kPa. In a typical modern plant utilizing a vacuum process, the total pressure in stream 515 may be approximately 20 kPa, of which 40%, 40% and 20% are attributed to ClO₂, water vapor, and Cl₂, respectively. Accordingly, if a condensation step is included to extract the moisture (and the deuterium) in stream 515, the partial pressure of the ClO₂ may rise and exceed the decomposition threshold.

Accordingly, in a preferred embodiment, a rinse system 570 is included for the extraction of deuterium in the moisture within the ClO₂ and Cl₂ stream 515. The rinse system comprises a water-vapor exchange column through which stream 515 and an external source of water 565 (preferably de-mineralized water) equilibrate and deuterium is exchanged between the water vapor in stream 515 and the water 565. Preferably, the rinse system is approximately isothermal, with the temperature between the rinse water and water vapor provided by the chlorine dioxide generator being less than about 10 degrees Celsius. The column is preferably packed with a material resistant to ClO₂ and Cl₂. Exemplary packing materials may include, but not limited to, Teflon™, PVC and ceramics. Water 590 emerging from the isothermal rinse system 570 is provided to the primary system 500, where is it preferably added with enriched water 505 and provided to the HCl synthesis system.

In a preferred embodiment, the water 565 is warm water that limits the absorption of ClO₂. A preferred temperature range for the water is approximately 50° C. to 70° C.

It is well known that the dilution of the ClO₂ can be achieved both using water vapour in a vacuum system, or using air with an atmospheric pressure process. Those skilled in the art will recognize that a water wash column would function in the same fashion and at approximately the same temperature in both cases. Those skilled in the art would further appreciate that a difference in the sizing of equipment may be required, and as known or readily obtained using chemical engineering principles.

In another embodiment, the water 590 emerging from the isothermal rinse system is provided to the catalytic isotope exchange column 550 prior to entering the primary system 500. Preferably, water 590 is added to the exchange column at a height that provides optimal extraction of deuterium.

While the preceding embodiments have disclosed the modified systems for the production of chlorate and chlorine dioxide involving sodium chlorate, those skilled in the art will appreciate that other metals may be utilized in such processes, including, but not limited to, potassium and lithium.

Generally speaking, the present invention has provided distributed system for the production of heavy water where water with an augmented deuterium concentration is produced in remote plants, transported to a centralized heavy water plant, and provided as feed water to the centralized plant. There are numerous sources of hydrogen that can be used to produce feed water with an augmented deuterium concentration according to the invention. At equilibrium, the water feeding the catalytic exchange column in the remote plant can contain up to around three times more deuterium than an equimolar quantity of hydrogen (where the separation factor is about 3). This property could be beneficially harnessed in any distributed locations where feed water with an augmented deuterium concentration is produced, and preferably at those where an additional hydrogen stream is produced alongside a geographically remote plant. A portion of the water entering a remote plant can be used to extract additional deuterium from all or part of the additional hydrogen stream, potentially increasing deuterium production by up to a factor of about three (again, based on a typical separation factor). In other words, if one hydrogen source comes predominantly from water, additional deuterium can be gathered from one or more additional hydrogen streams to augment heavy water production, subject to the limitation that at least about one-third of the hydrogen originates in water. Ineluctably, the ratio of additional hydrogen to the hydrogen produced within the remote plant must be less than α−1, where α is the equilibrium deuterium to hydrogen ratio between liquid water and hydrogen gas in the catalytic exchange column (i.e the separation factor).

Preferably, the plant producing an additional hydrogen stream is located nearby the remote plant. Examples of other hydrogen sources include steam methane reformers, gasifiers arranged to produce hydrogen from reaction of any carbonaceous material, plants for the production of ammonia and methanol, and plants for petroleum refining. This improvement could be accomplished either by adding the additional hydrogen to the hydrogen stream from the remote plant but more usually by dividing the water supplied to the remote plant into two streams and using part to extract deuterium from the plant-produced hydrogen and part to extract deuterium from the additional hydrogen stream. In the former case, the additional hydrogen gas is preferably combined with the hydrogen gas stream from the remote plant at an appropriate location in the catalytic isotope exchange column where the deuterium concentration of the additional hydrogen and the hydrogen stream are approximately equal. In the latter case, the two water streams with enriched deuterium contents would be combined to provide water feed to the plant.

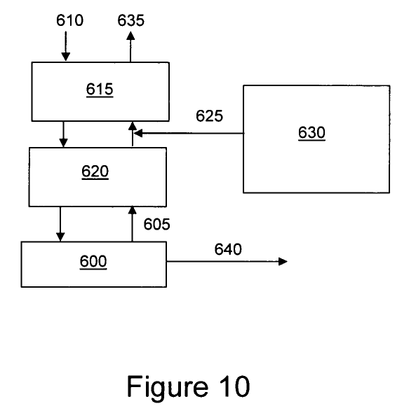

FIG. 10 shows a specific embodiment of the invention in which an additional source of hydrogen is provided to a catalytic exchange column that is used with a remote electrolysis plant. As shown in the figure, an addition source of adjacent independently produced hydrogen is added to the optimal location in the catalytic exchange column (as discussed above).

The system includes a remote plant with an electrolysis cell 600, which produces a hydrogen gas stream 605. Natural water 610 is fed in a counter current fashion down a stripping isotopic exchange column 615 and then to an enrichment isotopic exchange column 620, where it is enriched by the hydrogen gas stream 605. The water flowing down the stripping column is further enriched by the presence of an additional source of hydrogen gas 625 that is produced by a process 630 not involving the conversion of water. Feed water with an augmented deuterium concentration is obtained at 640 and transported to a centralized CECE plant (not shown), preferably with one or more additional augmented feed streams with from other geographically distributed plants.

As discussed above, an alternative embodiment includes separating the feed water 610 into two separate streams, where a first stream is passed down a first catalytic exchange column where it is contacted with and flows counter-current to hydrogen produced in the plant, and a second stream is passed down a second catalytic exchange column where it is contacted with and flows counter-current to hydrogen from the additional hydrogen source. In this embodiment, the two streams are preferably combined and fed to a third isotope exchange column, were the streams are contacted with and flow counter-current to the hydrogen produced in the plant, before being fed to the plant as feed water. In this embodiment, the hydrogen gas produced in the plant is first provided to the third column and is then provided to the first column.

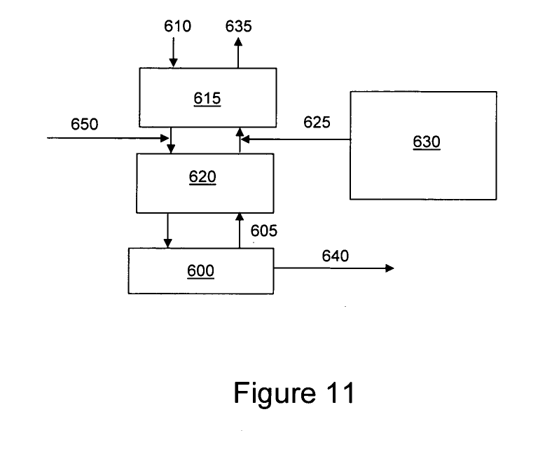

In another embodiment, an additional source of hydrogen can be added to the isotopic exchange column of the central CECE plant that is also supplied with feed water having an augmented deuterium concentration. Such an embodiment is shown in FIG. 11, where the CECE process shown is the first stage in a central CECE plant (i.e. enriched stream 640 becomes an input feed to a second CECE stage that is not shown in the figure). As in FIG. 10, an additional hydrogen stream 625 is added to the stripping column 615. In a preferred embodiment shown in the Figure, pre-enriched water 650 from one or more distributed hydrogen-producing plants is added to the enrichment column 620.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. An apparatus for the production of deuterium-enriched water, comprising:
a) a chlorate production system, said system comprising an electrolytic cell for electrolyzing an aqueous mixture comprising brine and hydrochloric acid, wherein said electrolytic cell produces hydrogen gas;
b) an isotope exchange column, wherein feed water for said chlorate production system is first provided to said isotope exchange column and flows counter-current to said hydrogen gas within said isotope exchange column before entering said chlorate production system;
c) means for the extraction of deuterium-enriched water from said chlorate production system; and
d) means for reducing a loss of deuterium from said chlorate production system.

2. The apparatus according to claim 1 wherein one or more water sources provided to said chlorate production system are first passed through said isotope exchange column.

3. The apparatus according to claim 1 wherein one or more chemicals consumed within said chlorate production system that require dilution are diluted with water passed through said isotope exchange column.

4. The apparatus according to claim 3 wherein said one or more chemicals are selected from the list comprising barium chloride, filter aid, hydrochloric acid, sodium dichromate, sodium hydroxide, soda ash, and hydrogen peroxide.

5. The apparatus according to claim 1 wherein water emerging from said isotope exchange column enters said chlorate production system at one or more locations selected from the list comprising a salt dissolving tank, a centrifugation system, and an air scrubbing system.

6. The apparatus according to claim 1 wherein said means for the extraction of deuterium-enriched water comprises the collection of condensate from vapor within said electrolytic cell.

7. The apparatus according to claim 1 wherein said means for the extraction of deuterium-enriched water comprises collecting a portion of said water emerging from said isotope exchange column.

8. The apparatus according to claim 1 wherein said means for the extraction of deuterium-enriched water comprises the collection of condensate from said hydrogen gas.

9. The apparatus according to claim 1 wherein said means for the extraction of deuterium-enriched water comprises collecting condensate from a chlorate crystal drying system.

10. The apparatus according to claim 1 wherein said means for the extraction of deuterium-enriched water comprises the extraction of liquid within said electrolytic cell, wherein said liquid is further purified to remove chemical impurities.

11. The apparatus according to claim 1 wherein said deuterium-enriched water has a deuterium concentration greater than about 2000 ppm.

12. The apparatus according to claim 1 wherein said means for reducing a loss of deuterium from said system comprises the extraction of residual water from effluent produced by said system and returning said residual water to said system.

13. The apparatus according to claim 12 wherein said effluent comprises filter cake and said residual water is removed from said filter cake by a drum rolling dryer.

14. The apparatus according to claim 1 wherein said means for reducing a loss of deuterium from said system comprises extraction of residual water from one or more vapor streams exiting said system and the return of said residual water to said system, wherein said vapor streams may be emitted from sources within said system selected from the list comprising a brine purification system, a crystallization system, an air scrubbing system, and a cell gas scrubbing system.

15. The apparatus according to claim 1 wherein said means for reducing a loss of deuterium from said system comprises the capture and re-circulation of air employed in a crystal drying system after the recirculated air has been substantially dried.

16. The apparatus according to claim 1 wherein said means for reducing a loss of deuterium from said system comprises returning a backwash stream from an ion-exchange system to a primary brine purification system, wherein impurities comprising calcium, magnesium and sulfate salts are removed during brine purification by precipitation, flocculation, skimming and filtration.

17. The apparatus according to claim 1 wherein said means for reducing a loss of deuterium from said system comprises the extraction of residual water from one or more liquid effluent streams departing said system and the return of said residual water to said system.

18. The apparatus according to claim 17 wherein said extraction is achieved by vacuum distillation or heating.

19. The apparatus according to claim 1 wherein said chlorate production system is modified to return surplus deuterium-enriched water to said system.

20. A method of producing deuterium-enriched water, comprising the step of:
a) providing feed water to an isotope exchange column, wherein said feed water contacts and flows counter-current to hydrogen gas within said isotope exchange column;
b) providing water emerging from said isotope exchange column to a chlorate production system, said system comprising an electrolytic cell for electrolyzing an aqueous mixture comprising brine and hydrochloric acid, and wherein said hydrogen gas is produced in said system;
c) extracting deuterium-enriched water from said system; and
d) adapting said system to reduce a loss of deuterium from said system.

21. The method according to claim 20 wherein one or more water sources provided to said chlorate production system are first passed through said isotope exchange column.

22. The method according to claim 20 wherein one or more chemicals consumed within said chlorate production system that require dilution are diluted with water passed through said isotope exchange column.

23. The method according to claim 22 wherein said one or more chemicals are selected from the list comprising barium chloride, filter aid, hydrochloric acid, sodium dichromate, sodium hydroxide, soda ash, and hydrogen peroxide.

24. The method according to claim 20 wherein water emerging from said isotope exchange column enters said chlorate production system at one or more locations selected from the list comprising a salt dissolving tank, a centrifugation system, and an air scrubbing system.

25. The method according to claim 20 wherein said deuterium-enriched water is extracted by collecting condensate from vapor within said electrolytic cell.

26. The method according to claim 20 wherein said deuterium-enriched water is extracted by collecting a portion of said water emerging from said isotope exchange column.

27. The method according to claim 20 wherein said deuterium-enriched water is extracted by collecting condensate from said hydrogen gas.

28. The method according to claim 20 wherein said deuterium-enriched water is extracted by collecting condensate from a chlorate crystal drying system.

29. The method according to claim 20 wherein said deuterium-enriched water is extracted by extracting liquid within said electrolytic cell, wherein said liquid is further purified to remove chemical impurities.

30. The method according to claim 20 wherein said deuterium-enriched water has a deuterium concentration greater than about 2000 ppm.

31. The method according to claim 20 wherein said system is adapted to reduce a loss of deuterium from said system by extracting residual water from effluent produced by said system and returning said residual water to said system.

32. The method according to claim 31 wherein said effluent comprises filter cake and said residual water is removed from said filter cake by a drum rolling dryer.

33. The method according to claim 20 wherein said system is adapted to reduce a loss of deuterium from said system by extracting residual water from one or more vapor streams exiting said system and returning said residual water to said system, wherein said vapor streams may be emitted from sources within said system selected from the list comprising a brine purification system, a crystallization system, an air scrubbing system, and a cell gas scrubbing system.

34. The method according to claim 20 wherein said system is adapted to reduce a loss of deuterium from said system by capturing and re-circulating air employed in a crystal drying system after the recirculated air has been substantially dried.

35. The method according to claim 20 wherein said system is adapted to reduce a loss of deuterium from said system by returning a backwash stream from an ion-exchange system to a primary brine purification system, wherein impurities comprising calcium, magnesium and sulfate salts are removed during brine purification by precipitation, flocculation, skimming and filtration.

36. The method according to claim 20 wherein said system is adapted to reduce a loss of deuterium from said system by extracting residual water from one or more liquid effluent streams departing said system and returning said residual water to said system.

37. The method according to claim 36 wherein said extraction is achieved by vacuum distillation or heating.

38. The method according to claim 20 wherein said chlorate production system is modified to return surplus deuterium-enriched water to said system.

39. An Integrated Process chlorine dioxide production apparatus adapted for the production of deuterium-enriched water, said system comprising:
a) an isotope exchange column, wherein feed water for said system is first provided to said isotope exchange column, said feed water contacting and flowing counter-current to hydrogen gas within said isotope exchange column before entering said system, wherein said hydrogen gas is produced in said system;
b) means for the extraction of deuterium-enriched water from said system; and
c) means for reducing a loss of deuterium from said system.

40. The apparatus according to claim 39 wherein water emerging from said isotope exchange column is used to dilute hydrochloric acid produced within said system.

41. The apparatus according to claim 39 wherein said means for the extraction of deuterium-enriched water comprises the collection of condensate from vapor evolved within an electrolytic cell in said system.

42. The apparatus according to claim 39 wherein said means for the extraction of deuterium-enriched water comprises collecting a portion of said water emerging from said isotope exchange column.

43. The apparatus according to claim 39 wherein said means for the extraction of deuterium-enriched water comprises the collection of condensate from said hydrogen gas.

44. The apparatus according to claim 39 wherein said means for the extraction of deuterium-enriched water comprises the extraction of liquid within an electrolytic cell, wherein said liquid is further purified to remove chemical impurities.

45. The apparatus according to claim 39 wherein said means for reducing a loss of deuterium from said system comprises a rinse system, wherein said rinse system comprises an exchange column wherein water vapor in a stream of chlorine dioxide and chlorine gas produced by said system is contacted with liquid water, wherein a temperature difference between said water vapor in said stream of chlorine dioxide and chlorine gas produced by said system is less than approximately 10 degrees, and wherein said liquid water is enriched with deuterium from said water vapor and wherein deuterium-enriched water emerging from said rinse system is provided as feed water to said system.

46. The apparatus according to claim 45 wherein said liquid water has a temperature that is selected to limit the absorption of chlorine dioxide in said column.

47. The apparatus according to claim 45 wherein said water emerging from said rinse system is used to dilute hydrochloric acid produced within said system.

48. The apparatus according to claim 45 wherein said water emerging from said rinse system is first fed through said isotope exchange column prior to being provided as feed water to said system.

49. The apparatus according to claim 48 wherein said water emerging from said rinse system is injected at an intermediate height within said isotope exchange column.

50. The apparatus according to claim 48 wherein said intermediate height is selected to obtain an optimal enrichment of said feed water.

51. The apparatus according to claim 45 wherein said column is packed with a material resistant to chlorine dioxide and chlorine gas.

52. The apparatus according to claim 51 wherein said material is selected from the list comprising Teflon™, PVC, and ceramics.

53. The apparatus according to claim 39 wherein said system is modified to return surplus deuterium-enriched water to said system.

54. A method of producing deuterium-enriched water comprising the steps of:
a) providing feed water to an isotope exchange column, wherein said feed water contacts and flows counter-current to hydrogen gas within said isotope exchange column;
b) providing water emerging from said isotope exchange column to an Integrated Process chlorine dioxide production system, wherein said hydrogen gas is produced in said system;
c) extracting deuterium-enriched water from said system; and
d) adapting said system to reduce a loss of deuterium from said system.

55. The method according to claim 54 wherein said water emerging from said isotope exchange column is used to dilute hydrochloric acid produced within said system.

56. The method according to claim 54 wherein said deuterium-enriched water is extracted by collecting condensate from vapor evolved within an electrolytic cell in said system.

57. The method according to claim 54 wherein said deuterium-enriched water is extracted by collecting a portion of said water emerging from said isotope exchange column.

58. The method according to claim 54 wherein said deuterium-enriched water is extracted by collecting condensate from said hydrogen gas.

59. The method according to claim 54 wherein said deuterium-enriched water is extracted from liquid within an electrolytic cell, wherein said liquid is further purified to remove chemical impurities.

60. The method according to claim 54 wherein said system further comprises an rinse system to reduce a loss of deuterium, wherein water vapor in a stream of chlorine dioxide and chlorine gas produced by said system is contacted with liquid water in an exchange column, wherein a temperature difference between said water vapor in said stream of chlorine dioxide and chlorine gas produced by said system is less than approximately 10 degrees, and wherein said liquid water is enriched with deuterium from said water vapor and wherein deuterium-enriched water emerging from said rinse system is provided as feed water to said system.

61. The method according to claim 60 wherein said liquid water has a temperature that is selected to limit the absorption of chlorine dioxide in said column.

62. The method according to claim 60 wherein said water emerging from said rinse system is used to dilute hydrochloric acid produced within said system.

63. The method according to claim 60 wherein said water emerging from said rinse system is first fed through said isotope exchange column prior to being provided as feed water to said system.

64. The method according to claim 63 wherein said water emerging from said rinse system is injected at an intermediate height within said isotope exchange column.

65. The method according to claim 63 wherein said intermediate height is selected to obtain an optimal enrichment of said feed water.

66. The method according to claim 60 wherein said column is packed with a material resistant to chlorine dioxide and chlorine gas.

67. The method according to claim 66 wherein said material is selected from the list comprising Teflon™, PVC, and ceramics.

68. The method according to claim 39 wherein said system is modified to return surplus deuterium-enriched water to said system.
